(19) United States
(12) Patent Application Publication
(10) Pub. No.: US 2014/0237794 A1
(43) Pub. Date: Aug. 28, 2014

(54) Tool and Method for Removing a Pin From a Door Hinge

(71) Applicant: Martin Gosselin, Rigaud (CA)

(72) Inventor: Martin Gosselin, Rigaud (CA)

(21) Appl. No.: 13/835,468

(22) Filed: Mar. 15, 2013

(30) Foreign Application Priority Data
Feb. 25, 2013 (CA) 2806603

(51) Int. Cl. B25B 27/04

(52) U.S. Cl. CPC B25B 27/04
USPC 29/426.5; 29/275

(57) ABSTRACT

A tool and method of using the tool for removing a pin from a cylinder portion of a hinge. The tool comprises a grip portion, a peg portion and an indent portion. The peg portion is adapted to fit within the cylinder portion of the hinge. The indent portion is adapted to engage a head of the pin. The tool comprises a first surface opposite to the peg portion adapted to be hit, once the peg portion is positioned under the pin, for applying upward force on the pin. The tool also comprises a second surface adapted to be hit, once the indent portion is positioned below the head of the pin, for applying upward force to the head of the pin.

### TECHNICAL FIELD

The present invention generally relates to a hardware tool and, more specifically, to a multifunction hand tool.

### BACKGROUND

Removing a door from its hinges currently requires multiple tools and is time consuming.

The present invention addresses this problem.

### SUMMARY

A first aspect of the present invention is directed to a tool for removing a pin from a cylinder portion of a hinge. The tool comprises a grip portion for allowing a user to hold the tool, a peg portion and an indent portion. The peg portion is adapted to fit within the cylinder portion of the hinge. The indent portion is adapted to engage a head of the pin. The tool comprises a first surface opposite to the peg portion adapted to be hit, once the peg portion is positioned under the pin, for applying upward force on the pin. The tool also comprises a second surface adapted to be hit, once the indent portion is positioned below the head of the pin, for applying upward force to the head of the pin.

Optionally, the peg portion may be located at a first end and the indent portion may be located at a second end.

Optionally, the grip portion may be generally flat.

Optionally, the peg portion may extend substantially perpendicularly to the grip portion or the peg portion may be substantially parallel to the grip portion.

Optionally, the first surface may be located near the indent portion.

Optionally, the indent portion and the peg portion may be laterally offset and the first surface may not be on the indent portion.

Optionally, the indent portion may extend at an angle ranging between about 90 and about 150 degrees to the grip portion.

Optionally, the indent portion may extend substantially parallel to the grip portion.

Optionally, the second surface may be located near the indent portion. In a further option, a third surface is provided near the peg portion and is adapted to be hit, once the indent portion is positioned below the head of the pin, for applying upward force to the head of the pin.

Optionally, the grip portion may provide an S-shaped offset with the indent portion. In a further option, the second surface may be located on the S-shaped offset.

Optionally, the first surface may be located near the peg portion. The indent portion may further extend at an angle ranging between about 90 and about 150 degrees to the grip portion. The second surface may be located near the indent portion.

A second aspect of the invention is directed to a method for removing a pin from a cylinder portion of a hinge. The method comprises positioning a peg portion of a tool under the pin. The peg portion is adapted to fit within the cylinder portion of the hinge. The method also comprises hitting a first surface of the tool, once the peg portion is positioned under the pin, for applying upward force on the pin causing a gap between a head of the pin and the top of the cylinder portion of the hinge. Thereafter, the method comprises positioning an indent portion of the tool in the gap between the head of the pin and the hinge. The indent portion is adapted to engage the head of the pin. The method then comprises hitting, once the indent portion is positioned below the head of the pin, for applying upward force to the head of the pin.

Optionally, the tool comprises the per portion on a first end and the indent portion on a second end, the method further comprising, prior to positioning the indent portion of the tool in the gap, flipping the tool from the first end to the second end.

### BRIEF DESCRIPTION OF THE DRAWINGS

Further features and exemplary advantages of the present invention will become apparent from the following detailed description, taken in conjunction with the appended drawings, in which:

FIG. 1 is a perspective view of a first exemplary tool in accordance with the teachings of the present invention;

FIGS. 2A, 2B and 2C, together referred to as FIG. 2, are perspective views of a second set of exemplary tools in accordance with the teachings of the present invention;

FIG. 3A, 3B, together referred to as FIG. 3, are perspective views of a third set of exemplary tools in accordance with the teachings of the present invention;

FIG. 4A, 4B, together referred to as FIG. 4, are perspective views of a fourth set of exemplary tools in accordance with the teachings of the present invention;

FIG. 5 is a perspective view of a fifth exemplary tool in accordance with the teachings of the present invention; and

FIG. 6 is an exemplary flow chart of method for using a tool in accordance with the teachings of the present invention.

### DETAILED DESCRIPTION

A tool and a method for using the tool for removing a pin from a cylinder portion of a hinge are provided. The tool in accordance with the teachings of the present invention, while it may be useful in other applications, is referred to as a pin remover for the sake of simplicity. One exemplary advantage of the pin remover is that it becomes possible to use the pin remover and a hammer, without additional tools, to remove a pin from the cylinder portion of a door hinge. Skilled persons will understand that some users may still prefer to use multiple tools in addition to the pin remover, which does not affect the innovative features of the tool.

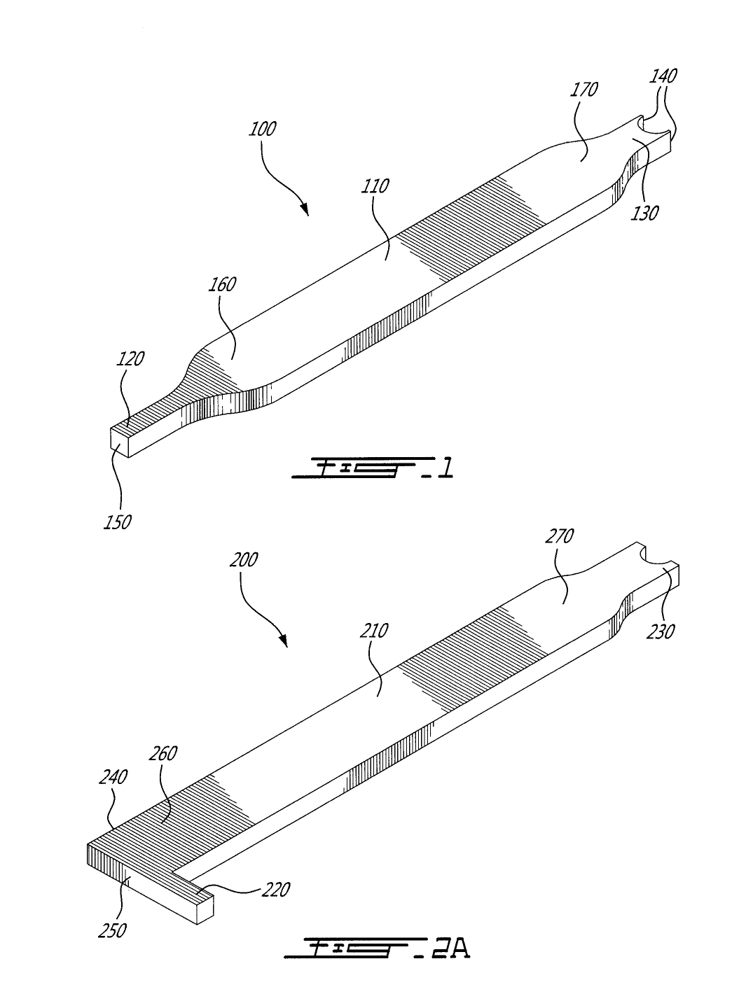

Reference is now made to the drawings, in which FIG. 1 shows an exemplary pin remover 100 in accordance with the teachings of the present invention. The pin remover 100 comprises a grip portion 110 for allowing a user to hold it, a peg portion 120 and an indent portion 130. The peg portion 120 is adapted to fit within the cylinder portion of the hinge (not shown). The indent portion 130 is adapted to engage a head of the pin (not shown). The pin remover 100 comprises a first surface 140 opposite to the peg portion 120 adapted to be hit, once the peg portion 120 is positioned under the pin, for applying upward force on the pin. The pin remover 100 also comprises a second surface 150 adapted to be hit, once the indent portion is positioned below the head of the pin, for applying upward force to the head of the pin.

In the example of FIG. 1, the peg portion 120 is located at a first end 160 and the indent portion 130 is located at a second end 170 of the pin remover 100. The peg portion 120 and the indent portions 130 are substantially parallel to the grip portion 110. The second surface 150 is located near the peg portion 120, at the first end 160 and the first surface 140 is located near the indent portion 130, at the second end 170. The second surface 150 may further be located at the second end 170 (not numbered for the sake of clarity) if, for instance, the indent portion 130 is inserted under the head of the pin substantially perpendicularly to the pin. As it is also illustrated on other Figures, this set of features illustrates only one of the multiple configurations in accordance with the teachings of the present invention.

In terms of exemplary measurements, the pin remover 100 of FIG. 1 may present the grip portion 110 of about 1.5 inch wide and between about 0.125 to 0.375 inch thick, a tip of the indent portion 140 of about 0.75 inch wide. The length of the pin remover 110 could be between around 6 and 12 inches. The peg portion 120 could present a peg of between about 0.125 to 0.375 inch in diameter or side, determined based on the expected size of the cylinder of the hinge. The peg may be generally round, square or otherwise, as long as it is usable to displace the pin of the hinge.

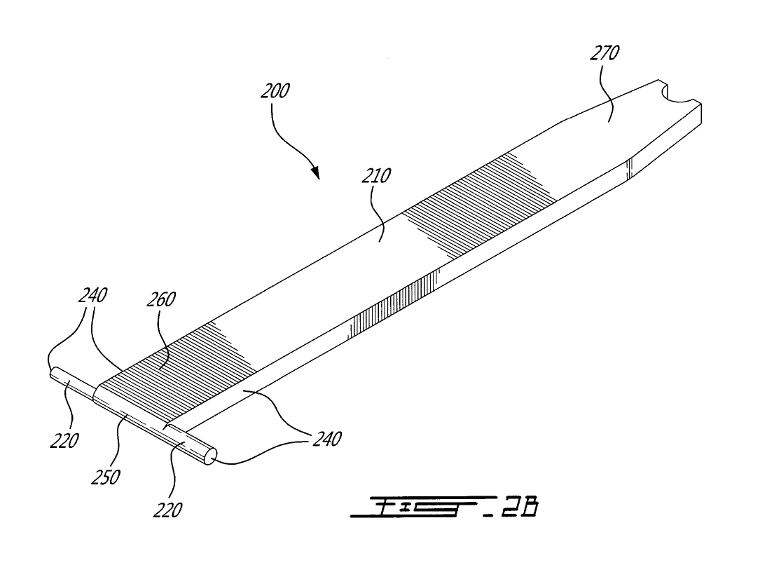

FIG. 2 shows an exemplary pin remover 200 in accordance with the teachings of the present invention. The pin remover 200 comprises a grip portion 210 for allowing a user to hold it, a peg portion 220 and an indent portion 230. The peg portion 220 is adapted to fit within the cylinder portion of the hinge (not shown). The indent portion 230 is adapted to engage a head of the pin (not shown). The pin remover 200 comprises a first surface 240 opposite to the peg portion 220 adapted to be hit, once the peg portion 220 is positioned under the pin, for applying upward force on the pin. The pin remover 200 also comprises a second surface 250 adapted to be hit, once the indent portion is positioned below the head of the pin, for applying upward force to the head of the pin.

In the example of FIG. 2, the peg portion 220 is located at a first end 260 and the indent portion 230 is located at a second end 270 of the pin remover 200. The peg portion 220 extends substantially perpendicularly from the grip portion 210 and the indent portion 240 is substantially parallel to the grip portion 210. The first surface 240 and the second surface 250 are located near the peg portion 220, at the first end 260. The second surface 250 may further be located at the second end 270 (not numbered for the sake of clarity) if, for instance, the indent portion 230 is inserted under the head of the pin substantially perpendicularly to the pin. As is also illustrated on other Figures, this set of features illustrates only one of the multiple configurations in accordance with the teachings of the present invention.

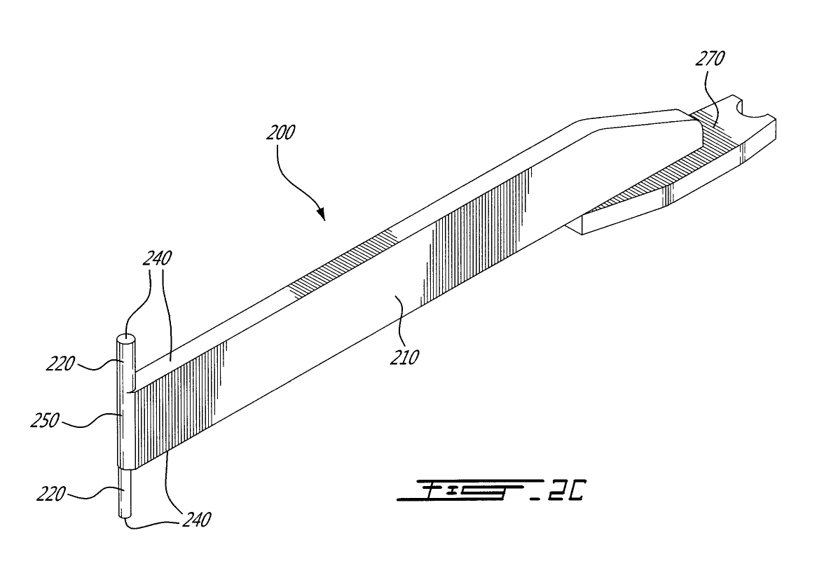

FIG. 3 shows an exemplary pin remover 300 in accordance with the teachings of the present invention. The pin remover 300 comprises a grip portion 310 for allowing a user to hold it, a peg portion 320 and an indent portion 330. The peg portion 320 is adapted to fit within the cylinder portion of the hinge (not shown). The indent portion 330 is adapted to engage a head of the pin (not shown). The pin remover 300 comprises a first surface 340 opposite to the peg portion 320 adapted to be hit, once the peg portion 320 is positioned under the pin, for applying upward force on the pin. The pin remover 300 also comprises a second surface 350 adapted to be hit, once the indent portion is positioned below the head of the pin, for applying upward force to the head of the pin.

In the example of FIG. 3, the peg portion 320 is located at a first end 360 and the indent portion 330 is located at a second end 370 of the pin remover 300. The peg portion 320 extends substantially perpendicularly from the first end 360 and the indent portion 340 is substantially parallel to the grip portion 310. In the example of FIG. 3, the grip portion 310 provides an S-shaped offset with the indent portion 330. The second surface 350 may thus be located on the S-shaped offset as shown or at the first end 360 (350′). The first surface 340 is located near the peg portion 320, on an opposite face of pin remover 300 at the first end 360. The S-shape offset is formed by angles θ and α. The angles θ and a are shown as being substantially congruent, but it should be understood that other combinations of angles could be used, which would lead to the grip portion 310 and the second end 370 not being perpendicular. As is also illustrated on other Figures, this set of features illustrates only one of the multiple configurations in accordance with the teachings of the present invention.

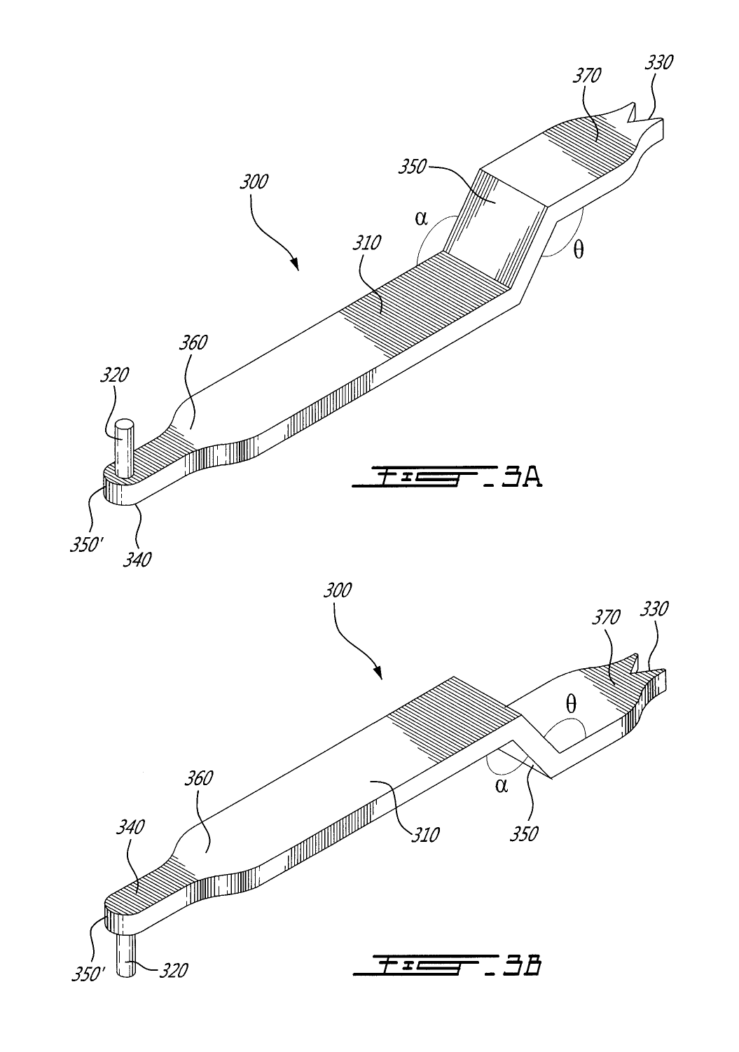

FIG. 4 shows an exemplary pin remover 400 in accordance with the teachings of the present invention. The pin remover 400 comprises a grip portion 410 for allowing a user to hold it, a peg portion 420 and an indent portion 430. The peg portion 420 presents a first pin 420A and a second pin 420B, which are adapted to fit within the cylinder portion of the hinge (not shown). The indent portion 430 is adapted to engage a head of the pin (not shown). The pin remover 400 comprises a first surface 440 opposite to the peg portion 420 adapted to be hit, once the peg portion 420 is positioned under the pin, for applying upward force on the pin. The pin remover 400 also comprises a second surface 450 adapted to be hit, once the indent portion is positioned below the head of the pin, for applying upward force to the head of the pin.

In the example of FIG. 4, the peg portion 420 is located at a first end 460 and the indent portion 430 is located at a second end 470 of the pin remover 400. The peg portion 420 extends substantially perpendicularly from the first end 460 and the indent portion 440 is substantially parallel to the grip portion 410. In the example of FIG. 4, the grip portion 410 and the indent portion 430 are at an angle cp, which is expected to be between 80 and 280 degrees (180 degrees being illustrated on other Figures), more preferably between about 90 and about 150 degrees. The first surface 440 is located near the peg portion 420, on an opposite face of pin remover 400 at the first end 460. As is also illustrated on other Figures, this set of features illustrates only one of the multiple configurations in accordance with the teachings of the present invention.

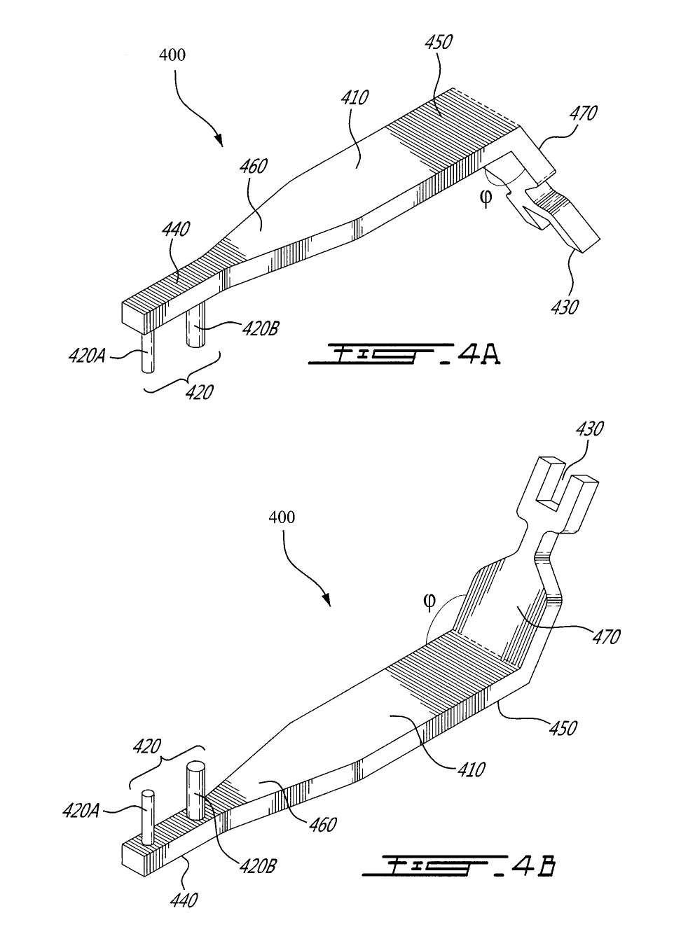

FIG. 5 shows an exemplary pin remover 500 in accordance with the teachings of the present invention. The pin remover 500 comprises a grip portion 510 for allowing a user to hold it, a peg portion 520 and an indent portion 530. The peg portion 520 presents a first pin 520A and/or a second pin 520B, which are adapted to fit within the cylinder portion of the hinge (not shown). The indent portion 530 is adapted to engage a head of the pin (not shown). The pin remover 500 comprises a first surface 540 and/or 540′ opposite to the peg portion 520 adapted to be hit, once the peg portion 520 is positioned under the pin, for applying upward force on the pin. The pin remover 500 also comprises a second surface 550 adapted to be hit, once the indent portion is positioned below the head of the pin, for applying upward force to the head of the pin.

In the example of FIG. 5, the peg portion 520 is located at a first end 560 and the indent portion 530 is located at a second end 570 of the pin remover 500. The peg portion 520 extends from the first end 560 and the indent portions 540 is substantially parallel to the grip portion 510. In the example of FIG. 5, the per portion 520 and the indent portion 530 are laterally offset from one another around an axis 580. The first surface 540 is located near the peg portion 520, but not directly thereon, at the first end 560. The second surface 540 is located near the indent portion 530, but not directly thereon, at the second end 570. As is also illustrated on other Figures, this set of features illustrates only one of the multiple configurations in accordance with the teachings of the present invention.

As is also illustrated on FIGS. 1 to 5, different set of features are provided to illustrate some of the multiple configurations in accordance with the teachings of the present invention. Persons skilled in the art will appreciate that the different options of shapes and positions of the different elements shown on the FIGS. 1 to 5 can be interchanged between illustrated examples without affecting the present invention. All the permutations are expected to be within the teachings of the present invention.

The different exemplary grip portions 110-510 are generally flat. Skilled persons will readily understand that any one of them could be cylindrical (not shown), shaped otherwise (not shown), or be of a different length without affecting the teachings of the present invention.

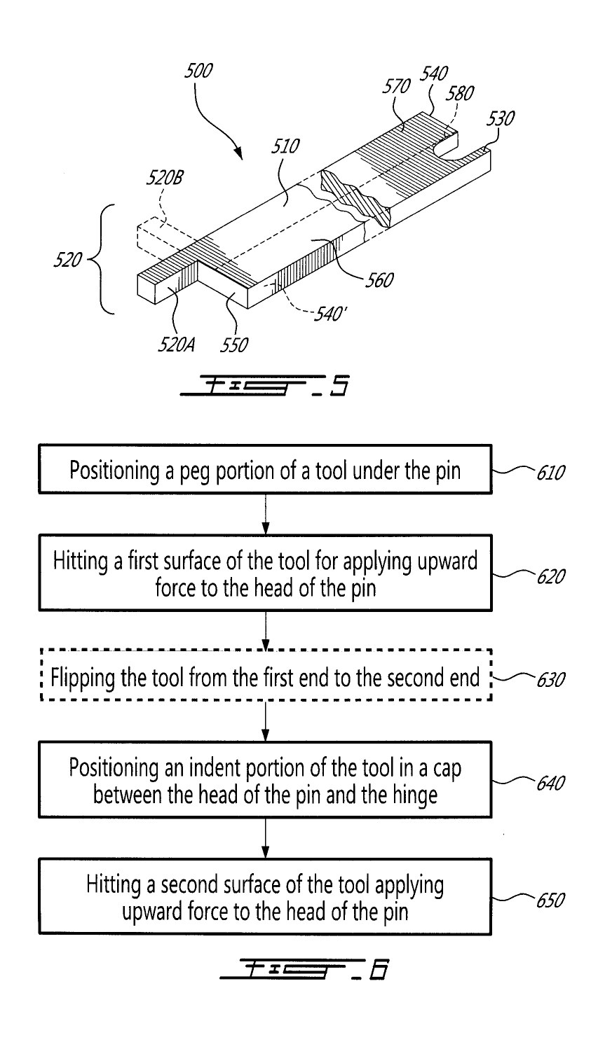

FIG. 6 shows an exemplary flow chart 600 illustrating a method for using an exemplary pin remover for removing a pin from a cylinder portion of a hinge. The method comprises positioning a peg portion of the pin remover under the pin 610. The peg portion is adapted to fit within the cylinder portion of the hinge. The method also comprises hitting a first surface of the tool 620, once the peg portion is positioned under the pin, for applying upward force on the pin causing a gap between a head of the pin and the top of the cylinder portion of the hinge. Optionally, the method may comprise flipping the tool 630. Thereafter, the method comprises positioning an indent portion of the tool in the gap between the head of the pin and the hinge 640. The indent portion is adapted to engage the head of the pin. The method then comprises hitting 650, once the indent portion is positioned below the head of the pin, for applying upward force to the head of the pin.

The description of the present invention has been presented for purposes of illustration, but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses. Elements of the drawings are not drawn to scale.

What is claimed is:

1. A tool for removing a pin from a cylinder portion of a hinge comprising:
(a) a grip portion for allowing a user to hold the tool;
(b) a peg portion adapted to fit within the cylinder portion of the hinge;
(c) a first surface opposite to the peg portion adapted to be hit, once the peg portion is positioned under the pin, for applying upward force on the pin;
(d) an indent portion adapted to engage a head of the pin; and
(e) a second surface adapted to be hit, once the indent portion is positioned below the head of the pin, for applying upward force to the head of the pin.

2. The tool of claim 1, wherein the peg portion is located at a first end and the indent portion is located at a second end.

3. The tool of claim 2, wherein the grip portion is generally flat.

4. The tool of claim 2, wherein the peg portion extends substantially perpendicularly to the grip portion.

5. The tool of claim 2, the peg portion is substantially parallel to the grip portion.

6. The tool of claim 1, wherein the first surface is located near the indent portion.

7. The tool of claim 1, wherein the indent portion and the peg portion are laterally offset and the first surface is not on the indent portion.

8. The tool of claim 6, wherein the indent portion extends at an angle ranging between about 90 and about 150 degrees to the grip portion.

9. The tool of claim 8, wherein the second surface is located near the indent portion.

10. The tool of claim 6, wherein the indent portion extends substantially parallel to the grip portion.

11. The tool of claim 10, further comprising a third surface near the peg portion adapted to be hit, once the indent portion is positioned below the head of the pin, for applying upward force to the head of the pin.

12. The tool of claim 9, wherein the grip portion provides an S-shaped offset with the indent portion.

13. The tool of claim 11, wherein the second surface is located on the S-shaped offset.

14. The tool of claim 1, wherein the first surface is located near the peg portion.

15. The tool of claim 14, wherein the indent portion extends at an angle ranging between about 90 and about 150 degrees to the grip portion.

16. The tool of claim 15, wherein the second surface is located near the indent portion.

17. The tool of claim 14, wherein the indent portion extends substantially parallel to the grip portion.

18. A method for removing a pin from a cylinder portion of a hinge comprising:
(a) positioning a peg portion of a tool under the pin, the peg portion being adapted to fit within the cylinder portion of the hinge;
(b) hitting a first surface of the tool, once the peg portion is positioned under the pin, for applying upward force on the pin causing a gap between a head of the pin and the top of the cylinder portion of the hinge;
(c) positioning an indent portion of the tool in the gap between the head of the pin and the hinge, the indent portion being adapted to engage the head of the pin;
(d) hitting, once the indent portion is positioned below the head of the pin, for applying upward force to the head of the pin.

19. The method of claim 18, wherein the tool comprises the per portion on a first end and the indent portion on a second end, the method further comprising, prior to positioning the indent portion of the tool in the gap, flipping the tool from the first end to the second end.
